(19) United States
(12) Patent Application Publication
(10) Pub. No.: US 2003/0046150 A1
(43) Pub. Date: Mar. 6, 2003

(54) System and method of advertiser-subsidized customizable ordering and delivery of multimedia products

(76) Inventors: Jamie Ader, Santa Monica, CA (US); Michael Ford Wells, Encinitas, CA (US)

Correspondence Address: OPPENHEIMER WOLFF & DONNELLY LLP, Suite 3800, 2029 Century Park East, Los Angeles, CA, 90067, US

(21) Appl. No.: 09/920,514

(22) Filed: Aug. 1, 2001

(51) Int. Cl. G06F 17/60

(52) U.S. Cl. 705/14

(57) ABSTRACT

A system and method of delivering multimedia content and advertising provides a remote user with the ability to order customized media and advertising via a physical media or broadband network. The price of a media selection may be reduced by the inclusion of the advertising. The system provides remote users with access to a database of media content and the ability to interactively search that content. Remote users may also order content and advertising organized under special interest groups or in niche categories that the user identifies. Users may also specify a delivery format for their ordered media and advertising.

### BACKGROUND OF THE INVENTION

1. Field of the Invention

The invention relates generally to a media delivery system. Specifically, the invention relates to a system and method of customizable ordering of media and delivery of ordered media to remote users via a physical media or network.

2. General Background and State of the Art

The field of media distribution today is a field governed by the principles of mass production and distribution channels. By and large, consumers have access only to content that distributors feel worthy of mass reproduction and only if they are able to obtain the content through one of the distributors' distribution channels. A new system of media content delivery that solves these problems would be a boon for distributor and consumer alike.

By obviating the need to maintain physical inventory, a distributor's or retailer's inventory is no longer dependent on the amount of physical space available, and the cost of operating the business will diminish proportionately. Additionally, because of the low cost of holding inventory, there is almost no penalty to keeping a very wide variety of content, thereby increasing the potential market for a distributor's goods.

In the industry today, one piece of content is typically mass-produced by distributors based on demand, and that content is selected for production based on the distributors' opinion of the content's potential market. Not only does this system limit which content is chosen for manufacture, but it produces a by-product in the fact that the mass-produced content must be made available through distribution channels, which may further limit the availability of content. By providing an electronic storefront to a large online content database, consumer selection will no longer be constrained by its pre-sale potential and distribution. Not only that, but distributors will be freed from the need to perform market research in order to determine which content to mass produce, thereby providing more cost savings.

The mass production, “cookie cutter” approach to manufacture and distribution also provides no means for the customization of video content based on an individual consumer's preferences. Digital storage and “just in time” creation of the content mean that the video content can be easily customized, thereby providing consumers more freedom and selection.

Accordingly, it is desirable to have a media delivery system where the need for mass production is eliminated. In summary, this media delivery system provides key benefits to both business and consumer. The business benefits through the decreased cost of operating the business due to an all-digital inventory and also benefits from the ability to “stock” niche video content for almost no cost thereby attracting audiences for that content. Consumers benefit by having the ability to obtain customized video content and access to advertiser-subsidized products.

In addition, a problem specifically related to the mass production of Digital Video Discs (DVD) is the requirement of manually authoring of the media content to create a master for replication. Development of traditional, mass-produced DVD media involves three distinct steps: encoding, authoring, and pre-mastering. In the encoding step, the audio/video content is converted and compressed into the digital audio and video formats required for DVD-Video, such as Moving Picture Expert Group standard (MPEG-2). During authoring, all of the audio and video content is manually assembled and combined with menus and other additions to make up the complete digital content of the DVD. Finally, the pre-mastering step involves formatting a disc image that will be used for mass production. The mass production process is known as replication.

Therefore, it is advantageous to have a new process that eliminates or automates one of the three steps. For example, there is no need for pre-mastering or replication, since a DVD-R burner will create all discs on demand. Also, after the content is encoded, the audio/video content in its entirety are stored in a database, which will enable the means for automatic authoring.

### SUMMARY OF THE INVENTION

The invention is designed to enable remote users to search a database of video content for the content they wish to view. After the selection of content, the user is given the option to determine whether advertising is to be included in the finished product in exchange for a reduction in cost of the product. If advertising is selected, the user is given the opportunity to choose the advertising to be included from a set of several targeted advertisers. The user is then prompted to select how they would like to receive the content. The delivery mechanism can be either a physical media, such as VHS tape, DVD, or Video-Compact Disc (VCD), or electronic delivery via a broadband network connection. The content is then assembled, including advertising, “just in time” from the database, and the assembled content is either passed on to hardware, which serves to create the physical media to be shipped to the consumer, or delivered electronically to the consumer via a broadband network connection. If a physical media is selected, the physical media is generated by a new process where authoring is automatic and no master template is needed.

The present invention is therefore designed to facilitate inventory selection for end users. The present invention assists these end users by matching their special interests with a selection of content organized in rankings/ratings of most popular to least popular. The system does this by having the end users register their special interests into the data base. It then matches their special interest properties with media and advertising properties. When end users want guidance to discover their special interest categories and media that meets their needs, the system helps them identify the categories best suited to them and their situations by responding to a series of questions. The present invention makes the selection process of media fast, easy, cost-effective and satisfying. The present invention offers content owners and distributors a consistent methodology of reaching end users cost-effectively with the content most likely to have specific appeal to them. The system directs end users to where the media can be acquired and facilitates their ability to purchase it there.

Advertising, which takes a blanket demographic approach in massed produced content, can not only be targeted more directly in a system of on-demand manufacturing, but the invention allows for the consumers to control the amount and type of advertising to appear in their final product, and therein the consumer will ultimately have the ability to have a say in how much they will pay for the product. Furthermore, the distributor has an opportunity to create competition among advertisers for the customer base, potentially resulting in advertiser competition to offer the best discounts to consumers.

The infrastructure for this system is a computer network, which enables each component of the system to communicate with one another in order to work together to find, define, customize, purchase, manufacture, and deliver video content for the consumer. The global Internet computer network, which uses Transmission Control Protocol/Internet Protocol (TCP/IP) to exchange data between machines, is an ideal network for such an application.

The preferred embodiments of this system would enable consumer's web browsers to view the system's user interface remotely, from anywhere on the Internet, using TCP/IP to exchange data. The user interface will enable a user to search for content or browse for content within various pre-defined categories. Upon selection of a content element, the user interface will employ the widely-used “shopping cart” metaphor for storing and managing all of the content the user is interested in purchasing. When the user wishes to purchase the content, the user interface will enable them to choose the method of delivery of the content (digitally or physically) and the media type upon which to store physical content. The system will then suggest advertisers to the user based on demographic information collected about that specific user, and the user interface will provide the option to select advertising in exchange for some discount in price. After that, the user interface will collect payment information, such as credit card details, and begin the process for assembly and delivery via broadband or manufacture of the content.

In another embodiment, the present invention offers media or content owners a brand or brands (advertisers) to finance a promotional campaign surrounding the media or content in return for the brand obtaining exposure for their brand alongside the media. In this embodiment, the media or content owners have the ability to select from an assortment of brands or products offering subsidies and determine which brand and/or product along with which subsidies they are willing to accept to offset the costs of their marketing and promotions.

### BRIEF DESCRIPTION OF THE DRAWINGS

FIG. 1 is a flowchart representation of system architecture involved in the present invention;

FIG. 2 is a flowchart representation of the process of selecting from special interest categories;

FIG. 3 is a logical flow chart describing the process for customer-controlled assembly and delivery of audio/video content;

FIG. 4 is a logical flow chart describing the process for integration of permission-based advertising;

FIG. 5 is a logical flow chart describing the process for the automatic authoring of digital media; and

FIG. 6 is a logical flow chart describing the process for video content selection.

### DETAILED DESCRIPTION OF THE EMBODIMENTS

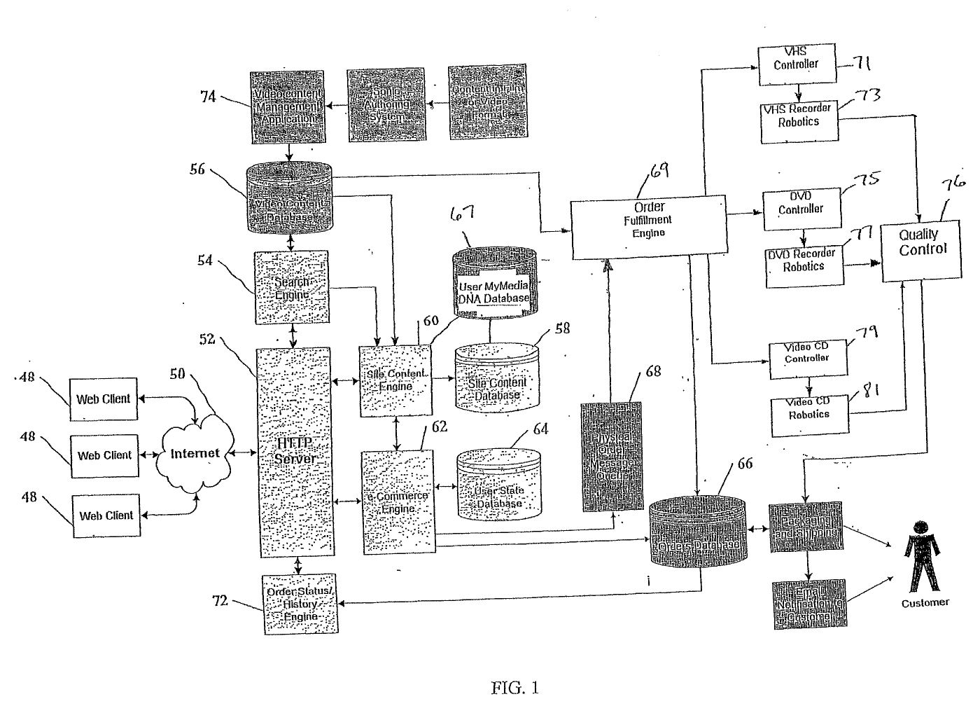

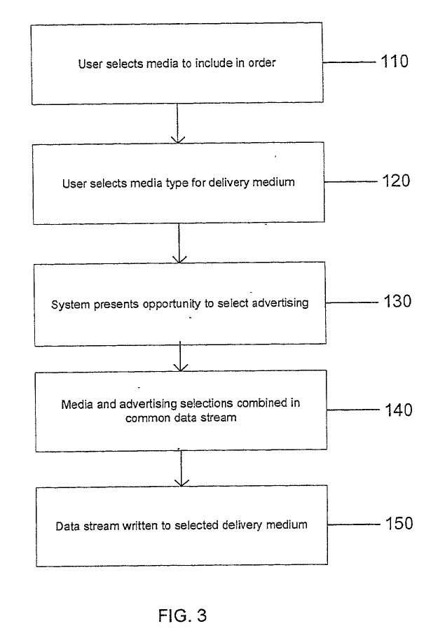

FIG. 1 is a flowchart representation of system architecture included in the present invention. FIG. 1 displays a particular embodiment of the present invention in which the content is delivered to the end user in DVD format. However, it is to be understood that any type of device may be used as a carrier to deliver content ordered by an end user, including but not limited to devices such as CD-ROM and video cassette tape. FIG. 1 shows web clients of blocks 48 connected to an Internet 50. Web clients 48 may include any number of remote locations through which users, owners and distributors, and advertisers may connect to the computer network 50 of the present invention. Web clients 48 interact with the computer network 50 through a series of user interface applications. Web clients 48 may include computer terminals at a variety of locations which are capable of accessing the user interface applications. In this embodiment, the computer network 50 of the present invention is the Internet 50. The computer network 50 also includes a server 52, a search engine 54, and a content database 56, shown in the embodiment shown in FIG. 3 as a video content database to be used in authoring DVDs. The content database 56 may include a plurality of databases at different geographic locations, each containing content uploaded by content owner and/or distributor. The system also includes a site content database 56 coupled to a site content engine 60. The site content database 58 includes the template information submitted by content owners and distributors as well as advertisers, and the actual promotional material uploaded by those advertisers. The system also includes an e-commerce engine 62 coupled to a user-state database 64, an orders database 66 and a physical order message queue 68. These devices assist the computer network in processing and executing orders by end users. The physical order message queue 68 and the orders database 66 couple with an order fulfillment engine 69 to initiate the process of transferring content to the DVD embodiment. From there, DVD products are processed and shipped to the consumer. In this DVD embodiment, the order fulfillment engine 69 includes a DVD authoring server and couples with a DVD controller 71 and a DVD Recorder Robotics component 73.

The components of the system can be divided into three distinct categories: Client control, content management, and fulfillment center. The Client control process enables remote clients to view and manipulate the user interface for the system in order to control the ordering and manufacturing process. The Client (such as web client 48) is a machine on the computer network 50 running web browser software such as for example Netscape Navigator or Microsoft Internet Explorer. This web browser can be running on any hardware/operating system platform capable of communicating using the Hypertext Transport Protocol (HTTP) over TCP/IP, rendering information sent by the system in Hypertext Markup Language (HTML) and capable of running script written in the JavaScript language and applications or applets written in the Java programming language.

The Clients will communicate over the computer network 50 such as the Internet with the HTTP Server 52. The server 52 is responsible for serving the above-mentioned text, script, and programs to many Clients that are simultaneously connected to the system. The server 52 functionality can be achieved using an existing HTTP server product, such as Microsoft Internet Information Server, Netscape Server, or Apache. Several “engines” manage the integration between the server 52 and the rest of the system. These engines can be implemented using one or more commonly accepted HTTP server integration technologies, such as Common Gateway Interface (CGI), Java servlets, Active Server Pages (ASPs), Internet Server Application Programmer Interface (ISAPI) and Netscape Server Application Programmer Interface (NSAPI).

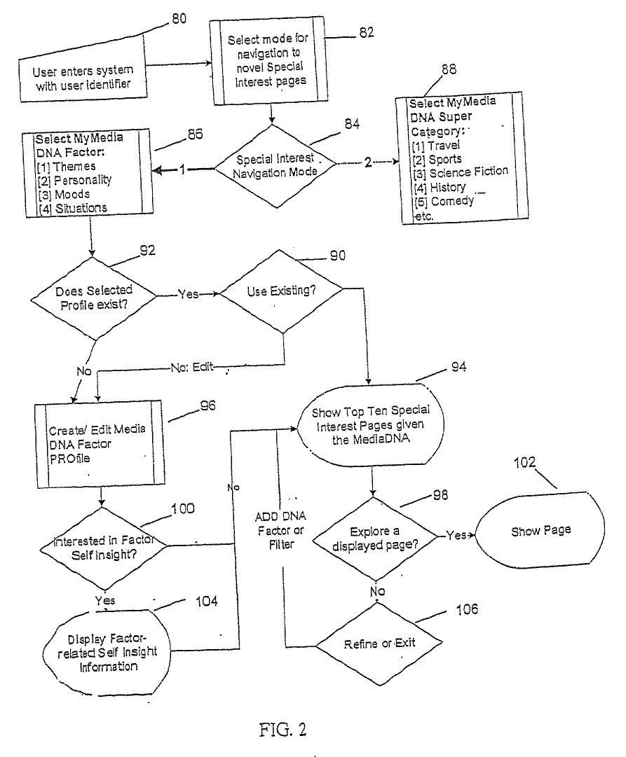

The search engine 54 provides the means by which a client can search for preferred video content. The search engine 54 identifies and retrieves video content from the online content database 56. The text content included within the system is obtained via the site content engine 60 and the site content database 58. The content database 56, which is a database stored and managed using a database management system such as the Oracle 8i Database Management System with Oracle interMedia, holds all of the system's video content and attributes of the content, and it is populated and maintained by the content management system described herein. Effectively, the content database 56 is the product inventory for this system, maintaining potentially terabytes or petabytes of video assets. The site content database 58 therefore coordinates with the customer information and the special interest information obtained to provide content aimed at particular interests of customers, as described herein and shown in FIG. 2. The User MyMedia DNA database 67 stores this special interest information described in FIG. 2. Using the search engine 54, clients are able to enter statements and specify search criteria in order to find specific video content elements in the inventory or find further information on said content.

The site content engine 60 works with the site content database 58, the content database 56, and HTML documents located on the server 52 in order to provide the user interface applications to the Clients. The site content database 58 can be maintained on a separate database, for example an Oracle database or another type of database more conducive to interaction with a particular HTTP server. The site content engine 60 gathers information from all of these sources, formats it into HTML and script templates, and passes that information back to the browser via the server 52. A shopping cart engine enables clients to “shop” for video content by selecting the various pieces of video content they wish to purchase and storing references to the video content in the site content database 58. An HTTP “cookie” or similar method of state management will be used to maintain the correlation with specific Client sessions and shopping cart data.

The e-commerce engine 62 is responsible for accepting customer payments information, verifying payments details with a financial clearing house component, and starting the order fulfillment process. Prior to fulfilling the orders, the e-commerce engine 62 selects the appropriate advertising content for the given order based on the contents of the order and/or the profile or demographic data of the purchaser and provides the purchaser with the opportunity to include this advertising in exchange for some amount of discount on the cost of the products ordered. Order fulfillment begins by posting a message to the physical order message queue 68 to begin the physical media fulfillment process, which is described in detail below.

The order status/history engine 72 communicates with the orders database 66 in order to provide clients with the status of past orders. Examples of status information include whether an order had been manufactured, whether it has been shipped, and package tracking information. This status information is assembled in HTML format and sent back to the Client.

The content management portion of the system deals with the acquisition, addition, and maintenance of video content. The process begins with content in its original format, which is converted to the proper format for digital storage using, for example, DVD Creator from Sonic Solutions. As with other specific products mentioned herein, the embodiments of the present invention are not limited to the use of specific products except where specifically indicated. Other such products providing similar functions from a variety of sources may also be used for digital storage and other functions presented herein. The appropriate format for video data is the MPEG-2 format, which is the native storage format for DVD-Video. After conversion, a human operator will employ the video content management application 74, which communicates directly with the content database 56 to add, modify, delete, and otherwise maintain the video content assets.

The fulfillment center is the portion of the system that transfers the purchased video content from the content database 56, assembles the content in the correct order and format, and transfers the content to physical media, such as DVD, VHS cassette tape, or Video-CD. This process begins when the order fulfillment engine 69 pulls a manufacture request from the physical order message queue 68. Ideally, the physical order message queue 68 will be implemented using existing technology, such as Microsoft Message Queue (MSMQ), Microsoft COM+, or IBM MQ Series. The format of the messages placed in the queue contains references to the video content (from the content database 56) that needs to be manufactured and references to the customer and order information (contained in the orders database 66). The order fulfillment engine 69 also makes an entry into the orders database 66 to indicate the order is now in the manufacturing phase. In accordance with the web client's selected physical media type, the order fulfillment engine 69 will activate the appropriate media production unit, such as the VHS controller 71 and VHS recorder robotics 73, the DVD controller 75 and DVD recorder robotics 77, or Video CD controller 79 and Video CD robotics 81.

After gathering content and advertising from the content database 56, a menu system will be dynamically developed from a template, which will provide a main menu for the media, as is customary for this type of DVD media. The prepared menus are also integrated into the custom DVD during these stages. The finished DVD disc data is then passed to a production tool, such as for example the Rimage Producer 2000 Protege or Rimage Producer 2000 Autostar, for the final production burn onto standard DVD-R media. It is noted that the present invention may utilize other products performing similar production functions. The production systems control and monitor the media burner robotics to manufacture the physical media. A tracking identifier will also be printed onto the disc at this time, to “tag” it with the order identification.

For VHS and other sequential-access types of media, the video content is assembled in the correct order, integrated with the appropriate advertising based on consumer selection, and the resultant video stream is provided to the VHS Controller 71, which will control the VHS Recorder Robotics 73 to produce the physical media. The VHS Controller 71 and VHS Recorder Robotics 73 elements will likely be built from existing technologies, such as Odetics server/robotics/VTR units, which provide technology for converting an MPEG-2 video data stream to VHS video content.

DVD, Video-CD, and similar random-access types of media will be produced in a slightly different manner. After gathering content and advertising from the Video Content Database 56, a menuing system will be automatically developed from a template, which will provide a main menu for the media, as is customary for this type of media. The content is then passed to the Controller for assembly in a format required for the specific media (e.g., DVD-Video or Video-CD), and then the content is passed to the media burner robotics to manufacture the physical media.

After the manufacture of the DVD or other product carrier, the product undergoes a human quality control 76 phase to verify the integrity of the content. If quality control 76 is passed, the order is labeled, packaged and shipped and an entry will be made in the orders database 66 to update order status to “shipped”, and an email notification will be sent to the customer notifying them of the shipment. If quality control 76 discovers defective content, the order will be placed back in the physical order message queue 68 for remanufacture.

FIG. 2 is a flowchart showing the steps involved in a session process in which a user navigates the system of the present invention to discover media matching special interests in layered categories. A user enters the system in block 80 and enters a identifier to allow access to the system. The user then selects a mode for navigation to special interest pages in block 82 and then enters that navigation mode in block 84. Within the selection of mode for navigation, two mode options are presented: a mode for discovering MyMedia DNA, and a mode for layered categories. Once in the special interest navigation mode of block 84, the user may either select a MyMedia DNA factor as shown in block 86 (such as for example themes, personality, moods and situations) or select a MyMedia Super Category as shown in block 88 (such as for example travel, sports, science fiction, history, and comedy). From these blocks, the system then checks to see if a users selected profile is already existing as shown in block 92. If so, the system asks whether the user wishes to use the existing profile (as shown in block 90), and if so the user is directed to a page to view a top ranking of special interest pages given the user's DNA as shown in block 94. The user is asked whether a displayed page is to be explored (block 98), and if so the page is shown (block 102). If a displayed page is not to be explored, the system adds a DNA factor or filter and repeats the process or exits the system, as shown in block 106.

If no profile is already existing, or the user wishes to edit their existing profile, then the system proceeds to create or edit a user profile as shown in block 96. The system asks whether the user is interested in factor self-insight (block 100). If no, the system proceeds to display a ranking of special interest pages in block 94. If yes, the system displays factor-related self-insight information (block 104) and then proceeds to display the ranking of special interest pages as shown in block 94.

The present invention additionally provides services such as helping members find the specific media in categories they want and need, displaying a selection of available titles within each category, providing information on the selected titles within a category, advising members on titles to buy based on the shared experiences of others within that special interest group, lowering the price by offering advertising of choice, offering multiple fulfillment methods including custom CDs/DVDs, organizing special promotions including branded programming to highly targeted markets, and facilitating low customer acquisition cost for advertisers.

The present invention also includes a media mapping function to facilitate the selection of media based upon layered categories and special interests. Media maps are created in one of two ways. One way is an immediate drill down to special interest domains via hierarchically organized special interest categories (illustrated partially below for the SPORTS Super-Category—one of 12-20 such high level categories of Special Interest Domains). SPORTS includes Team Sports> (Major Category), Played on Ice> (Minor Category), Hockey (Special Interest Domain), Curling, Played in the Water>, Water Polo, Team Relay Swimming, Team Synchronized Swimming, Played on a marked field>, Soccer, Football, Basketball, Baseball, Tennis Doubles, Lacrosse, Individual Sports. A second way of creating a media map is through a journey of media interest Discovery (MyMediaMapper) by completing one or more optional Media Interest PROfiles {Theme PROfile, Mood PROfile, Personality PROfile, Time PROfile, Location PROfile) or Media Motivators {Situations, Goals, Experiences). Both ways of creating media maps cumulatively build the member's special interest map.

The audience for media may be directed to several types of categories, such as Primary Language (English, French, German, Italian, Spanish) and Dialect (Business Professionals, Skilled and Unskilled Laborers, Mothers with Children, College Students, Teenagers). Media may also be directed to a particular theme, such as Realistic (practical, athletic, straightforward/frank, mechanically inclined, nature oriented), Investigative (inquisitive, analytical, scientific, observant, precise scholarly, cautious, intellectually self-confident, introspective, reserved, broad-minded logical, complex, curious), Artistic (creative intuitive imaginative innovative unconventional emotional independent expressive original introspective impulsive sensitive courageous open complicated idealistic nonconforming), Social (friendly, helpful idealistic insightful outgoing understanding cooperative generous responsible forgiving patient empathic kind persuasive), Enterprising (self-confident assertive sociable persuasive enthusiastic energetic adventurous popular impulsive ambitious inquisitive agreeable talkative extroverted spontaneous optimistic initiate projects convince people to do things your way sell things or promote ideas give talks or speeches organize activities lead a group persuade others make decisions affecting others be elected to office win a leadership or sales award start your own service or business campaign politically meet important people have power or status), and Conventional (conservative, well-organized accurate numerically inclined, family oriented, methodical conscientious efficient conforming orderly practical thrifty systematic structured polite ambitious obedient persistent).

Media may also be directed according to a particular mood, such as Angry/Disgusted, Tired/Worn Out, Anxious/Nervous, Depressed/Sad, Sexy/Romantic, Happy/Elated, Curious/Thoughtful, Calm/Serene, and Mischievous/ Funny. Media may also be directed to a particular timeframe, such as time based upon period depicted, for example Geologic (more than 100,000 years ago), Tribal Age (from 100,000-5000 BC), Agricultural Age (from 5000 to 1000 BC), Age of Trade (from 1000 BC to 1800 AD), Industrial Age (19^{th} Century), Financial Age (1900-1960), Information Age (1960-Present), Near Future (21^{st} Century), Distant Future (22^{nd} Century and beyond), and multiple periods. Additionally, timeframe may be based upon when created, such as Pre-Classical, Classical, Roaring 20s, Dirty 30s, Forties, Fifties, Sixties, Seventies, Eighties, Nineties, and New Millennium. Media may be layered according to country of origin as well.

Media may also be layered according to personality, such Counselor, Visionary, Leader, Observer, Planner, Persuader, and Advisor. The personality function is a component provided to the system of the present invention by Behavior Description Systems, PO Box 5546 Station A, Calgary, Alberta, Canada, T2T 1K4.

Goals may also be a category, having possible subcategories such as Comfort/Feel Better, Become fit, Acquire/improve a knowledge or skill, and Getting a date. Situations and/or experiences may also be used to organize media, such as Getting married, Getting dumped, Getting divorced, and Starting a new job.

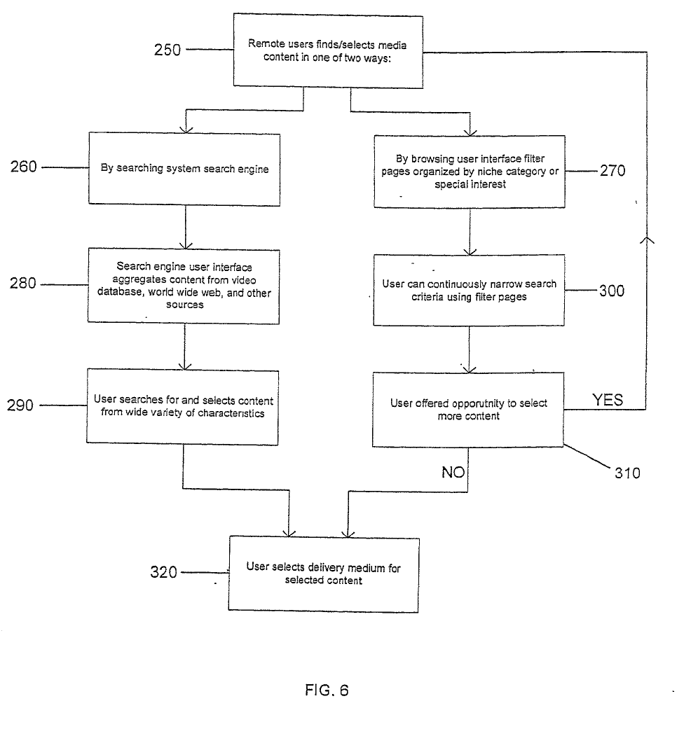

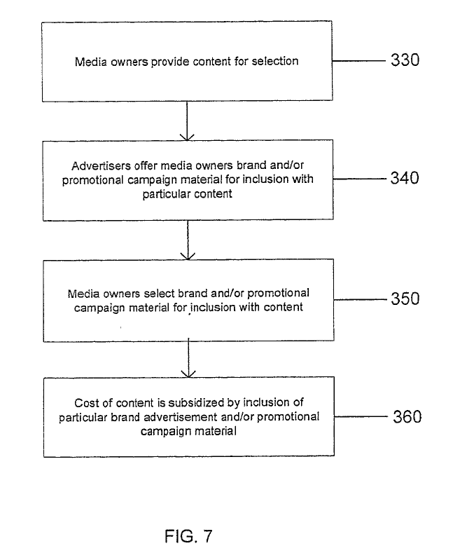

FIG. 3 describes the process for customer-controlled assembly and delivery of audio/video content. In block 110, the user selects the video content to be included in the order, a process that is described in detail in FIG. 6. The selection of video to be delivered can come from the video database 56 or be supplied by the remote user. The remote user has complete control over the order and presentation of the media, and is given means to manipulate the content such as creation of personalized video animation for greeting cards, creation of movie trailers, or creation of original composition of scenes and footage. After selecting the content they wish to purchase, the customer selects the delivery mechanism for the content as shown in block 120. This deliver mechanism can be a physical medium, such as DVD-Video, VHS tape, or Video-CD or an electronic medium, such as real-time video streaming via a broadband network connection.

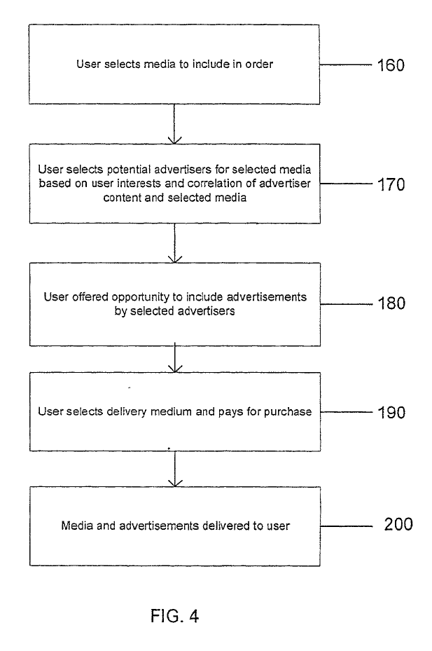

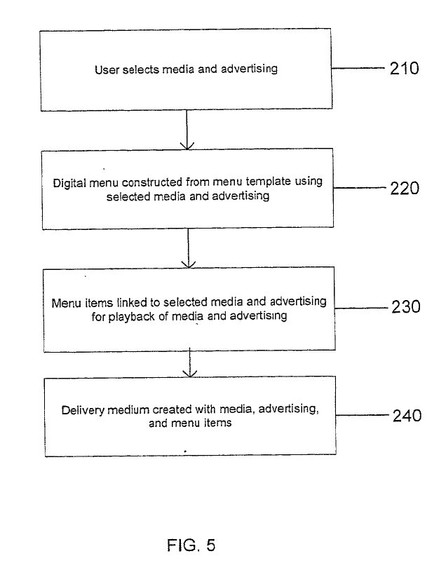

After selecting the deliver mechanism, the customer is offered the opportunity to include advertising in their customized product as shown in block 130, a process that is further explained in more detail in FIG. 4. The selected video elements are then combined with the selected advertising to form a single video as shown in block 140. This video stream can then be used to create physical media (detailed in FIG. 5) or sent back to the customer via a broadband network connection or some other delivery medium in block 150.

FIG. 4 describes the process for integration of permission-based advertising. After the customer selects the audio/video elements they wish to purchase in block 160, potential advertisers are then selected for this purchase in block 170. Potential advertisers are selected based on two factors:

1. The demographic and personal information known about the current customer.

2. Correlations between the product or service being advertised and the content being purchased. For example, leather pants may be advertised to a customer that is attempting to purchase heavy metal music videos.

After the computer selects the potential advertisers, block 180 shows the step in which the customer is offered the opportunity to choose to include advertising from the presented advertisers. Advertising can be selected in exchange for a price reduction or other incentives. Advertisers can compete to provide consumers the most attractive benefits if their advertising content is included, potentially even including free product. Finally, the customer selects a delivery medium and purchases the selected media in block 190, and is delivered the media in block 200, as described in FIG. 3 and FIG. 5.

In the authoring stage of the conventional production of DVD media, all of the audio and video content is manually assembled and combined with menus and other additions to make up the complete digital content of the DVD. FIG. 5 describes the process for the automatic authoring of digital media in accordance with the present invention. This process begins after the content and advertising have been selected by the customer, as shown in block 210. The selected content is then assembled into a coherent video stream as described in block 140 of FIG. 3 in preparation for being integrated onto digital media such as DVD-Video or Video-CD. After this, a digital media menu is built in computer memory from a menu template, using each of the audio/video and advertising elements as an item in the menu in block 220. The menu items are then linked to the audio/video and advertising elements so that selection of the menu item in a digital media player will result in the playback of the selected element in block 230. The physical media is then created in block 240 by combining the audio/video content stream and automatic menu.

The automatic authoring process is implemented by a software program that retrieves the audio/video content ordered by the customer from the Video Content Database 56. This content is combined with the advertising content, also pulled from the Video Content Database 56 into several MPEG-2 streams that will reside on the DVD. Based on this content, DVD menus will be built automatically using a graphical template and content titles as menu choices. This is most easily done by sending scripting commands to an off-the-shelf DVD authoring software tool, such as that provided by Sonic Solutions, Minerva, and Astarte. Finally, all of these elements are combined and written to a multi-gigabyte computer hard disk and the DVD-R disc is created using the hard disk files as a source.

FIG. 6 describes the process for selection of video content. The customer finds and select audio/video content in one of two ways in block 250: content can be searched for using the system search engine in block 260 or it can be browsed for using the browsing user interfaces in block 270. If the customer chooses to search in block 260, they are presented with the search engine user interface, which aggregates content from the video database 56, other parts of the system web site, and other information sources on the web as shown in block 280. Using the aggregated search functionality, the customer searches for and find movies based on a variety of heuristics, including genre, date of production, artists, producer, director, etc, as shown in block 290. If the customer chooses to browse for content in block 270, they are presented with a user interface that effectively lets them “drill down” into specific content by continuously narrowing the search criteria using filter pages for niche categories and special interests as shown in block 300. For example, they can drill down into filter pages by genre, going from there into horror films, then into black and white, then into vampires, then into films set in Transylvania. Once the content element is selected, the user is presented with the opportunity to select more content in block 310. If yes, the user returns to block 250. Otherwise, the user moves on to select the delivery means as described in block 320 and in FIG. 3.

FIG. 7 shows a flowchart describing another embodiment of the present invention in which media or content owners are offered a brand or brands (advertisers) to finance a promotional campaign surrounding the media or content in return for the brand obtaining exposure for alongside the media. Block 330 shows the step of media owners providing content on the system of the present invention for selection. Advertisers offer media owners the opportunity to select promotional campaigns and/or advertisements for specific brands or products, as shown in block 340. The media or content owners then have the ability to select from an assortment of brands or products from advertisers offering subsidies for the inclusion of their advertisements, as shown in block 350. Media owners in this block determine which brand and/or product along with which subsidies they are willing to accept to offset the costs of their own marketing and promotions. The cost of the content is therefore subsidized in block 360 by the inclusion of this brand, product and promotional campaign media.

The above embodiments are only illustrative of the principles of this invention and are not intended to limit the invention to the particular embodiments described. One skilled in the art should recognize that media could include all types of information that can be reduced to a tangible medium or delivered via broadband to remote user, and not limited to delivery of video programs. For example, media could include gaming software, audio programs, text of books, newspaper articles, or non-entertainment information such as medical records, manufacturing specifications, and the like. Accordingly, various modifications, adaptations, and combinations of various features of the described embodiments can be practiced without departing from the scope of the invention as set forth in the appended claims.

1. A method of delivering media for customized selection and pricing from a database having digital format of media stored thereon and available to individual remote users, the method comprising:
providing a selection of media and a selection of advertisement, the selection of media having a variety of prices;
selecting media and advertisement based on a desired price for the selected media;
selecting a delivery format for the selected media; and
delivering the selected media on the delivery format.

2. The method of claim 1, wherein a plurality of filters, each filter relating to a particular niche category, are used to provide a selection of media.

3. The method of claim 1, wherein a plurality of virtual storefronts, each storefront relating to a particular niche category are used to provide a selection of media.

4. The method of claim 1, further comprising providing a selection of media organized by brand and special interest of a remote user.

5. The method of claim 1, further comprising allowing an advertiser to register an advertisement,

6. The method of claim 5, further comprising allowing the advertiser to establish a price for subsidizing a media selection.

7. The method of claim 1, further comprising presenting a selection of pricing opportunities to the remote user.

8. A method of providing permission-based advertising, the method comprising:
providing a portal to a remote user via a network;
presenting a selection of pricing opportunities to the remote user;
presenting a selection of media and a selection of advertisement based on a selected pricing opportunity; and
selecting desired media and advertisement.

9. The method of claim 8, further comprising delivering the desired media and advertisements to the remote user.

10. The method of claim 8, wherein a plurality of filters, each filter relating to a particular niche category, are used to provide a selection of media.

11. The method of claim 8, wherein a plurality of virtual storefronts, each storefront relating to a particular niche category are used to provide a selection of media.

12. The method of claim 8, further comprising providing a selection of media organized by brand and special interest of a remote user.

13. The method of claim 11, further comprising creating a network of virtual storefronts of media for each niche category.

14. The method of claim 11, further comprising identifying exclusive content under a specific brand or niche category.

15. The method of claim 11, further comprising managing the network of virtual storefronts for niche categories by providing the ability to create a filter page from any remote location.

16. The method of claim 15, wherein the filter page connects into the network of virtual storefronts to enable media selection within each niche category.

17. The method of claim 16, further comprising accessing the network of virtual storefronts for media selection from any remote location.

18. The method of claim 15, wherein said remote location is a website.

19. The method of claim 15, wherein said remote location is a television

20. The method of claim 15, wherein the remote location is a personal digital assistant.

21. The method of claim 15, wherein the remote location is a wireless handheld device telephone

22. The method of claim 8, further comprising allowing an advertiser to register an advertisement,

23. The method of claim 22, further comprising allowing the advertiser to establish a price for subsidizing a media selection.

24. The method of claim 8, further comprising offering a plurality of advertisements to owners of media or content to provide advertisers with a forum for a promotional campaign surrounding the media or content, wherein the media or content owners have the ability to select from the plurality of advertisements to offset costs of marketing and promotions for the media or content.

25. A method of providing customized selection of media from a database of media to individual remote users, the method comprising:
providing media for selection by a remote user;
providing a network for selecting the media;
allowing the remote user to register at least one special interest through said network;
providing a filter of said media using special interests identified by the remote user;
generating a physical medium by automatic authoring of the media selection onto the physical medium; and
delivering the physical medium to the remote user.

26. A method of customized selection of media from a database of media to individual remote users, the method comprising the steps of:
selecting one or more media by a remote user via a network;
authoring the selected media onto a physical medium; and
delivering the physical medium to the remote user.

27. The method of claim 26, wherein the one or more media is localized to a plurality of regions by sub-titling, dubbing, or translation of text to one or more languages.

28. The method of claim 26, further comprising storing a digital format of the one or more media in the database.

29. The method of claim 26, wherein the selection of one or more media includes a selection of one or more advertisements.

30. The method of claim 26, further comprising selecting one or more advertisements for authoring on the physical medium.

31. The method of claim 26, further comprising allowing an advertiser to register an advertisement,

32. The method of claim 31, further comprising allowing the advertiser to establish a price for subsidizing a media selection.

33. The method of claim 26, wherein demographic or personal information of the remote user is compiled by a commerce engine.

34. The method of claim 26, wherein the selected media is manipulated, rearranged, or altered by the remote user.

35. The method of claim 26, wherein the selected media further comprises content provided by the remote user.

36. The method of claim 26, further comprising offering the remote user the ability to create a personalized unique results table identifying special interests that comprise a personalized profile.

37. A media delivery system comprising:
a database storing digital format of media;
a virtual storefront on a network enabling a selection of media stored in said database; and
a fulfillment center for orchestrating delivery of a media selection, wherein the digital format of the media is transferred to a physical medium.

38. The media delivery system of claim 37, wherein delivery of the media selection occurs through a broadband video delivery engine.

39. The media delivery system of claim 38, wherein media selection through the broadband video delivery engine is transferred to one or more electronic devices for playback, recording, or manipulation.

40. The media delivery system of claim 37, wherein the database further comprises proxy versions of media, wherein a remote user can preview the media selection.

41. The media delivery system of claim 37, further comprising a filter page, the filter page managing a network of virtual storefronts providing niche categories for the selection of media and advertisement by the remote user.

42. The media delivery system of claim 41, wherein the filter page connects into the network of virtual storefronts to enable media selection within each niche category.

43. The media delivery system of claim 37, further comprising an authoring system for authoring the selected media and advertisement onto a physical medium.

44. An advertising method comprising the steps of:
selecting media via a network, wherein media selection is performed by a remote user;
presenting a selection of at least one advertisement to the remote user;
offering the at least one advertisement to the remote user to be included in the media selection; and
discounting the purchase price of the media selection based upon the at least one advertisement selected.

45. The method of claim 44, wherein the at least one advertisement is targeted to the media selection of the remote user on demographic or personal information compiled about the remote user.

46. A method of providing advertising for customized media, the method comprising offering a plurality of advertisements to owners of media or content to provide advertisers with a forum for a promotional campaign surrounding the media or content, wherein the media or content owners have the ability to select from the plurality of advertisements to offset costs of marketing and promotions for the media or content.
